(19) United States
(12) Patent Application Publication
(10) Pub. No.: US 2026/0353334 A1
(43) Pub. Date: Nov. 5, 2026

(54) A METHOD FOR CONFIGURING RESOURCES FOR SIDELINK POSITIONING REFERENCE SIGNAL TRANSMISSION, A RELATED RESOURCE ALLOCATING NODE AND A RELATED WIRELESS DEVICE

(71) Applicant: Sony Group Corporation, Tokyo (JP)

(72) Inventors: Basuki PRIYANTO, Lund (SE); Anders BERGGREN, Lund (SE); Yujie ZHANG, Lund (SE); Jose FLORDELIS, Lund (SE); Johan HILL, Lund (SE)

(21) Appl. No.: 19/100,095

(22) PCT Filed: Aug. 7, 2023
(86) PCT No.: PCT/EP2023/071829

§ 371 Date: Jan. 30, 2025

(30) Foreign Application Priority Data
Aug. 12, 2022 (SE) 2250962-4

(51) Int. Cl. H04W 64/00; H04L 5/00

(52) U.S. Cl. CPC H04W 64/00; H04L 5/0005

(57) ABSTRACT

Disclosed is a method, performed by a resource allocating node, for configuring resources for sidelink positioning reference signal transmission. The method comprises transmitting, to a wireless device, WD, a dedicated sidelink positioning resource configuration. The dedicated sidelink positioning resource configuration comprises an indication being indicative of a dedicated sidelink positioning resource to be used by the WD during a sidelink positioning procedure.

The present disclosure pertains to the field of wireless communications. The present disclosure relates to methods for configuring resources for sidelink positioning reference signal transmission, a related resource allocating node and a related wireless device.

### BACKGROUND

Sidelink communication has been used as part of the 3^{rd} Generation Partnership Project (3GPP) New Radio (NR) Vehicle to Everything (V2X). In NR V2X context, a radio network node, such as a gNB, may communicate directly to the wireless device (WD) using a Uu interface and the WD(s) may also communicate directly with each other using a PC5 interface. The WD in V2X may be a Road Side Unit (RSU), a vehicle, such as a car, comprising a communication module, a WD associated with a pedestrian and/or cyclist, etc. The WDs may communicate with each other via a sidelink, such as using a PC5 interface, without communicating via the radio network node. In the case that the WDs are within cell coverage of the radio network node, radio resources required for communication between WDs are allocated by the radio network node. For example, the network node can define the radio resources to be used for sidelink communication. The radio network node may grant the sidelink resources to the sidelink transmitting (Tx) WD using a downlink control channel. Prior to the transmission of sidelink communication, the Tx WD may transmit a sidelink control information so that the sidelink receiving (Rx) WD is aware of the upcoming sidelink transmission and is able to receive and decode the transmission.

Radio resources used for sidelink communications (such as for communication between WDs) are within a resource pool, such as a set of resources, to be used for sidelink communication. Transmissions of a reference signal, control channel, and data channel from one or more WDs are all within a given resource pool. For positioning purpose, a large number of frequency resources are needed, particularly for accurate positioning measurement. The amount of frequency resources required for positioning may be larger than the legacy resources available for communication purpose within a given sidelink resource pool. However, increasing a bandwidth of the resource pool for sidelink communications to accommodate positioning may not be efficient due to potential unused resources. Furthermore, increasing the bandwidth would increase the power consumption of the WD, as the UE would operate with a larger bandwidth for communication and/or positioning.

### SUMMARY

Accordingly, there is a need for apparatuses and methods for configuring resources for sidelink positioning reference signal transmission which may mitigate, alleviate or address the shortcomings existing and may provide an accurate positioning of a WD via sidelink, while improving the efficiency of the resource allocation.

Disclosed is a method, performed by a resource allocating node, for configuring resources for sidelink positioning reference signal transmission. The method comprises transmitting, to a wireless device, WD, a dedicated sidelink positioning resource configuration. The dedicated sidelink positioning resource configuration comprises an indication being indicative of a dedicated sidelink positioning resource to be used by the WD during a sidelink positioning procedure.

Further, a resource allocating node comprising memory circuitry, processor circuitry, and a wireless interface is provided. The resource allocating node is configured to perform any of the methods disclosed herein.

It is an advantage of the present disclosure that the available resources can be used more efficiently than legacy systems. By the resource allocating node configuring dedicated sidelink positioning resources separate from the legacy sidelink resources for communication, the bandwidth part available for positioning can be adapted, such as increased, to improve positioning accuracy when using sidelink. Further, by the resource allocating node configuring the dedicated sidelink positioning resource, the bandwidth part for the sidelink positioning resource can be increased without having to increase the bandwidth part for the legacy sidelink resource for communication. The size of the bandwidth part for the legacy sidelink resource for communication is thereby not required to be increased to provide the required positioning accuracy over sidelink, which would otherwise lead to an increase of unused resources in the sidelink bandwidth part since the sidelink communication typically requires less bandwidth than the sidelink positioning procedure. Further, the WDs use more power when monitoring or transmitting over a wider bandwidth. By configuring the dedicated resources for sidelink positioning, the bandwidth can be increased over a limited time period, such as during transmission of sidelink positioning reference signals, and thus the time the WDs have to monitor or transmit over the wider bandwidth can be reduced and/or limited. Correspondingly, the power consumption of the WDs can be reduced compared to using a wider bandwidth for non-dedicated resources.

Disclosed is a method, performed by a wireless device, WD, for configuring resources for sidelink positioning reference signal transmission. The method comprises receiving, from a resource allocating node, a dedicated sidelink positioning resource configuration. The dedicated sidelink positioning resource configuration comprises an indication being indicative of a dedicated sidelink positioning resource to be used by the WD during a sidelink positioning procedure. The method comprises performing a sidelink positioning procedure based on sidelink positioning reference signals transmitted in the dedicated sidelink positioning resource.

Further, a wireless device comprising memory circuitry, processor circuitry, and a wireless interface is provided. The wireless device is configured to perform any of the methods disclosed herein.

It is an advantage of the present disclosure that the available resources can be used more efficiently. By configuring the WD with dedicated sidelink positioning resources separate from the legacy sidelink resources for communication, the bandwidth part available for positioning purpose can be adapted to a required positioning accuracy. To improve the positioning accuracy over sidelink, the frequency allocation, such as bandwidth part of the dedicated sidelink positioning resources can be increased without having to increase the bandwidth part for the legacy sidelink resource for communication. The size of the bandwidth part for the legacy sidelink resource for communication is thereby not required to be increased to provide the required positioning accuracy over sidelink. This would otherwise lead to an increase of unused resources in the sidelink bandwidth part since the sidelink communication typically requires less bandwidth than the sidelink positioning procedure. Further, the WDs use more power when monitoring or transmitting over a wider bandwidth. By configuring the dedicated resources for sidelink positioning, the bandwidth can be increased over a limited time period, such as during transmission of sidelink positioning reference signals, thereby the time the WDs have to monitor or transmit over the wider bandwidth can be reduced. Correspondingly, the power consumption of the WDs can be minimized.

Disclosed is a method, performed by a location network node, for handling sidelink positioning. The method comprises receiving, from a resource allocating node, a dedicated sidelink positioning resource configuration. The dedicated sidelink positioning resource configuration comprises an indication being indicative of a dedicated sidelink positioning resource to be used by a wireless device, WD, during a sidelink positioning procedure. The method comprises sending, to the resource allocating node, a message triggering a sidelink positioning procedure in the dedicated sidelink positioning resource.

Further, a location network node comprising memory circuitry, processor circuitry, and a wireless interface is provided. The location network node is configured to perform any of the methods disclosed herein.

It is an advantage of the present disclosure that the available resources can be used more efficiently when the positioning procedure is initiated by the location network node. By informing the location network node about the dedicated sidelink positioning resources configured for the WD, the location network node can initiate a sidelink positioning procedure using the dedicated sidelink positioning resources. To improve the positioning accuracy over sidelink, the frequency allocation, such as bandwidth part of the dedicated sidelink positioning resources can be increased without having to increase the bandwidth part for the legacy sidelink resource for communication. The size of the bandwidth part for the legacy sidelink resource for communication is thereby not required to be increased to provide the required positioning accuracy over sidelink. This would otherwise lead to an increase of unused resources in the sidelink bandwidth part since the sidelink communication typically requires less bandwidth than the sidelink positioning procedure. Further, the WDs use more power when monitoring or transmitting over a wider bandwidth. By configuring the dedicated resources for sidelink positioning, the bandwidth can be increased over a limited time period, such as during transmission of sidelink positioning reference signals, thereby the time the WDs have to monitor or transmit over the wider bandwidth can be reduced. Correspondingly, the power consumption of the WDs can be minimized.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example radio network node, an example core network node and a plurality of example wireless devices according to this disclosure,

FIG. 2 is a block diagram illustrating a standard, such as a legacy, sidelink bandwidth part and resource pool,

FIG. 3 is a block diagram illustrating a standard, such as a legacy, sidelink resource allocation in uplink resources,

FIG. 4A-4C are block diagrams illustrating example dedicated sidelink positioning resource configurations according to this disclosure,

FIG. 5A-5C are block diagrams illustrating example control information allocations for signaling the dedicated sidelink positioning resource configurations according to this disclosure,

FIG. 6 is a signaling diagram illustrating an example message exchange for configuring sidelink positioning resources according to this disclosure,

FIG. 7 is a signaling diagram illustrating an example message exchange for configuring sidelink positioning resources according to this disclosure,

FIG. 8 is a flow-chart illustrating an example method, performed by a resource allocating node, for configuring resources for sidelink positioning reference signal transmission according to this disclosure,

FIG. 9 is a flow-chart illustrating an example method, performed by a wireless device, for configuring resources for sidelink positioning reference signal transmission according to this disclosure,

FIG. 10 is a flow-chart illustrating an example method, performed by a location network node, for handling sidelink positioning according to this disclosure,

FIG. 11 is a block diagram illustrating an example resource allocating node according to this disclosure,

FIG. 12 is a block diagram illustrating an example wireless device according to this disclosure, and

FIG. 13 is a block diagram illustrating an example location network node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

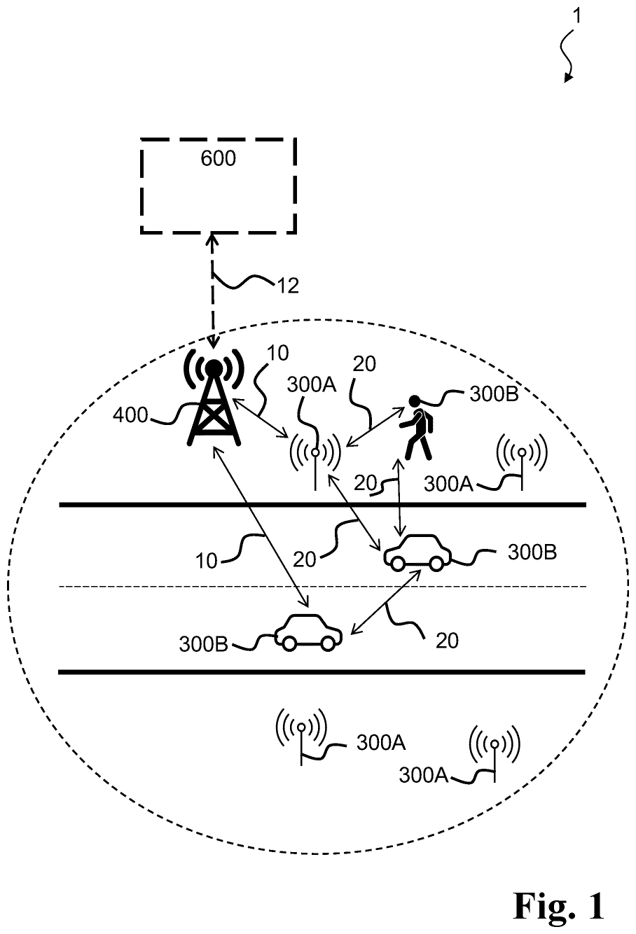

FIG. 1 is a diagram illustrating an example wireless communication system 1 comprising an example core network (CN) node 600, an example radio network node 400 and one or more example wireless devices 300A, 300B according to this disclosure.

As discussed in detail herein, the present disclosure relates to a wireless communication system 1 comprising a cellular system, for example, a 3GPP wireless communication system. The wireless communication system 1 comprises one or more wireless devices 300A, 300B, and/or a network node 400 and/or a CN node 600.

A radio network node disclosed herein refers to a radio access network (RAN) node operating in the radio access network, such as a base station, an evolved Node B, eNB, gNB in 3GPP New Radio (NR). A gNB may have one or more Transmission and Reception Point (TRP). In one or more examples, the RAN node is a functional unit which may be distributed in several physical units.

A CN node 600 disclosed herein refers to a network node operating in the core network, such as in the Evolved Packet Core Network, EPC, and/or a 5G Core Network, 5GC. Examples of CN nodes in EPC include a Mobility Management Entity (MME), and a Location Management Function (LMF).

A wireless device may refer to a mobile device and/or a user equipment, UE.

The wireless communication system 1 described herein may comprise one or more wireless devices 300A, 300B, and/or one or more radio network nodes 400, such as one or more of: a base station, an eNB, a gNB and/or an access point.

The wireless devices 300A, 300B may be configured to communicate with the radio network node 400 via a wireless link (or radio access link) 10, such as an air interface (Uu interface). The wireless devices 300A, 300B may be configured to communicate directly with each other via a sidelink 20, such as via a PC5 interface. The sidelink 20 is a wireless link.

The core network node 600 may be configured to communicate with the radio network node 400 via a link 12, such as a wired and/or wireless link, and/or with the one or more wireless devices 300A, 300B, via the radio network node 400.

Sidelink communication may be used as part of NR-V2X. The WDs 300A, 300B in V2X can be stationary WDs 300A, such as a Road Side Unit (RSUs), or non-stationary WDs 300B, such as vehicles having a communication module, or a Vulnerable Road User (VRU), such as a WD carried by a pedestrian and/or a cyclist. The WDs 300A, 300B can communicate with each other over sidelink 20, such as via a PC5 interface. The communication between the WDs 300A, 300B uses radio resources. In case the WDs 300A, 300B are within cell coverage of the radio network node 400, the radio resources may be allocated by the radio network node 400. For example, the radio network node 400 may define the radio resources to be used for the sidelink communication between the WDs 300A, 300B. The radio network node 400 may grant the sidelink resources to a sidelink transmitting (Tx) WD via a downlink control channel. The Tx WD may be the WD that initiates the sidelink communication with, such as transmits sidelink positioning reference signals to, a receiving (Rx) WD. Prior to the transmission of sidelink communication, the Tx WD may transmit a sidelink control channel so that the sidelink Rx WD is aware of the upcoming sidelink transmission and is able to receive and decode it.

The operation of sidelink resource allocation can be in two modes. In a first resource allocation mode, which may be referred to as Mode 1 resource allocation, the radio network node 400 performs the scheduling for the sidelink communications. This is typically operated when the sidelink WDs 300A, 300B are operated in-coverage of radio network node 400. In a second resource allocation mode, which may be referred to as Mode 2 resource allocation, the WD 300A, 300B, such as the Tx WD, autonomously selects the resources after performing a carrier-sensing operation.

A bandwidth part (BWP) used for sidelink communication may be defined similarly to the BWPs in Uplink (UL) and/or downlink (DL). This provides a convenient way to specify aspects relating to a WDs radio frequency (RF) hardware chain implementation. A WD 300A, 300B may be configured with one active sidelink BWP when in connected mode to a radio network node 400. The same numerology, including subcarrier spacing and other parameters (e.g., cyclic prefix), should be applied for the transmissions and receptions in a given sidelink BWP.

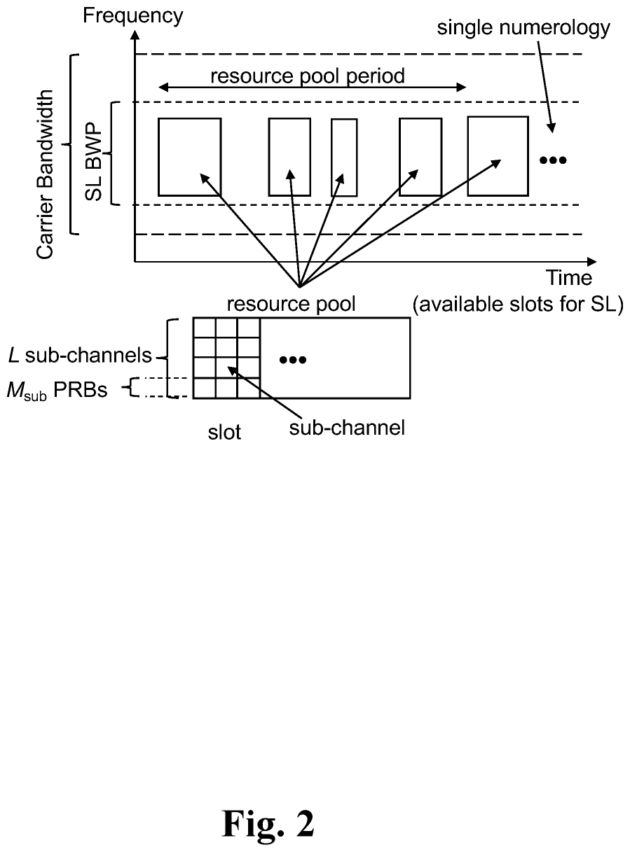

FIG. 2 discloses a sidelink bandwidth part and a resource pool (RP) for legacy sidelink communication. A resource pool concept has been defined for legacy sidelink communication (such as for Long Term Evolution (LTE) V2X, and/or NR V2X). A resource pool can be seen as a set of resources to be used for sidelink communications, such as between WDs 300A, 300B. The resource set consists of (time) slots and Resource Blocks (RB) to be used by several WDs for their sidelink transmissions. The legacy resource pool is to be allocated within a WD SL Bandwidth Part (BWP), such as within a single WD SL BWP. A single SL BWP herein means that the resource pool is only allocated in a BWP as the legacy WD operating SL is only configured with a single SL BWP. As shown in FIG. 2, a BWP may comprise one or more resource pools. Sidelink communication is mainly carried by a Physical Sidelink Control Channel (PSCCH) and a Physical Sidelink Shared Channel (PSSCH). PSCCH and/or resources may be defined within resource pools for the respective channels. A resource pool may be divided into sub-channels in the frequency domain, which are consecutively non-overlapping sets of Physical Resource Blocks (PRBs) (e.g., ≥10 PRBs) in a slot. The size of the resource pools may be dependent on (pre-)configuration settings. The resource allocation, carrier-sensing, and resource selection may be performed in units of a sub-channel.

For PSSCH and PSCCH transmission in mode 1, the radio network node 400 may allocate resources for sidelink WDs using three different methods, which are dynamic grant, configured grant (CG) type 1, and CG type 2. For dynamic grant, the radio network node 400 schedules the sidelink transmission of a single packet via Downlink Control Information (DCI). For CG type 1, the radio network node 400 provides, such as by Radio Resource Control (RRC) signaling, a sidelink resource allocation to the WD 300A, 300B. The WD 300A, 300B may use any of the resources it has been assigned for sidelink communication. For CG type 2, the radio network node 400 provides a sidelink resource allocation to the WD 300A, 300B by RRC. However, unlike for CG type 1, DCI is used to activate and/or deactivate the RRC grant. Typically, CG type 1 and CG type 2 are dedicated for a semi-persistent transmission with bulky configuration information, while the dynamic grant is used for single-packet transmission.

For sidelink communication between a Tx WD and an Rx WD, each transport block, such as each packet of data, that is passed between the Tx WD and the Rx WD has an associated sidelink control information (SCI) message. The SCI may be divided into two different stages, a first stage SCI carried by PSCCH and a second stage SCI carried by PSSCH. The two SCI stages may support different functionalities. The first stage SCI mainly comprises resource allocation information, while the second stage SCI comprises link-specific information, such as information related to the sidelink between the Tx WD and the Rx WD.

In mode 1, the radio network node may configure the resource allocation to the Tx WD via DCI or RRC. After that, the Tx WD may forward the resource allocation to the Rx WD via the first SCI. The purpose of using the first SCI may be twofold. On one hand, the first SCI is used for configuring the resource allocation for reception. On the other hand, the first SCI also signals to the other WDs in the same resource pool which frequency and time resources that are occupied. This is especially useful for the WDs performing sensing, such as carrier-sensing, to discover unoccupied resources in mode 2.

Unlike the first SCI, the second SCI mainly carries the link-associated information, which enables a decoding of the received signal and a determination of a feedback configuration, such as a configuration for hybrid automatic repeat request (HARQ). The second SCI may comprise parameters such as a source identifier (ID) and destination ID as well as an indicator indicating whether HARQ feedback is enabled and/or disabled.

The current disclosure provides methods for supporting positioning via sidelink, which may also be referred to as sidelink positioning. The Tx WD may be a WD configured to transmit sidelink positioning reference signals (SL-PRS) in sidelink, such as via the PC5 interface. The SL-PRS may be similar to a downlink positioning reference signal (DL-PRS) and/or an uplink positioning reference signal (UL-SRS) in the legacy Uu-link. The Rx WD may be configured to receive the SL-PRS transmitted by the Tx WD and may perform positioning measurements on the SL-PRS received. The WD that is to be positioned can herein be referred to as a target WD. The target WD may be either the Tx WD or the Rx WD depending on the positioning measurement that is performed. In order to perform SL-PRS transmission, the WDs 300A, 300B must be configured so that the WDs 300A, 300B, such as the Tx WDs and the Rx WDs, are aware of the time and/or frequency location and parameters of the SL-PRS.

Positioning of the target WD can be performed in a plurality of ways. According to a first example method according to this disclosure, the target WD may perform measurements of SL-PRS transmitted by a Tx WD, such as an RSU, a car, etc. This is similar to DL positioning via the Uu interface, where the WD measures on PRSs transmitted from the radio network node in DL. According to a second example method, the target WD (such as a VRU) may transmit SL-PRS for a supporting WD, such as a car and/or a pedestrian, to measure on. The supporting WD may send a positioning measurement report back to the target WD, or may send the positioning measurement report to a positioning network node, such as an LMF or a positioning entity in the network and/or the radio network node. This is similar to UL positioning via the Uu interface, where the WD transmits PRSs for the radio network node to measure on. In the sidelink case, a second WD may participate in the positioning of the target WD.

The framework or procedure of sidelink communication has been well established in 3GPP (such as in LTE and NR). Positioning utilizing sidelink is however not available yet. Sidelink positioning requires SL-PRS transmission and reception. It may also require a transmission with a large bandwidth, such as with a bandwidth larger than the resources currently defined for sidelink communication purpose.

The current disclosure thus provides methods for allocating resources for transmission of SL-PRS in a radio network node controlled operation (such as in sidelink mode 1) and a WD autonomous operation (such as in sidelink mode 2).

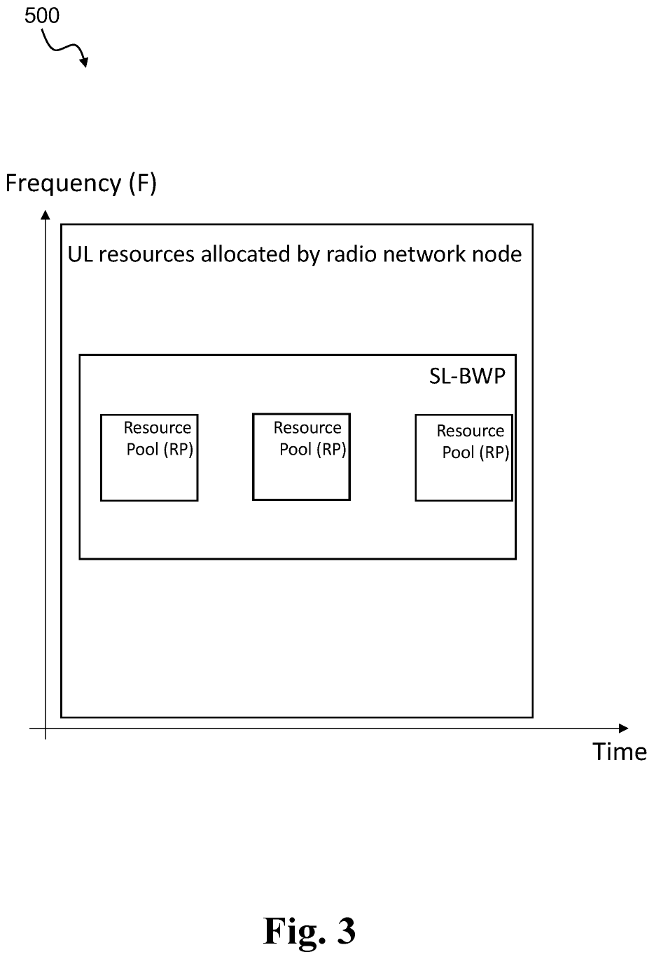

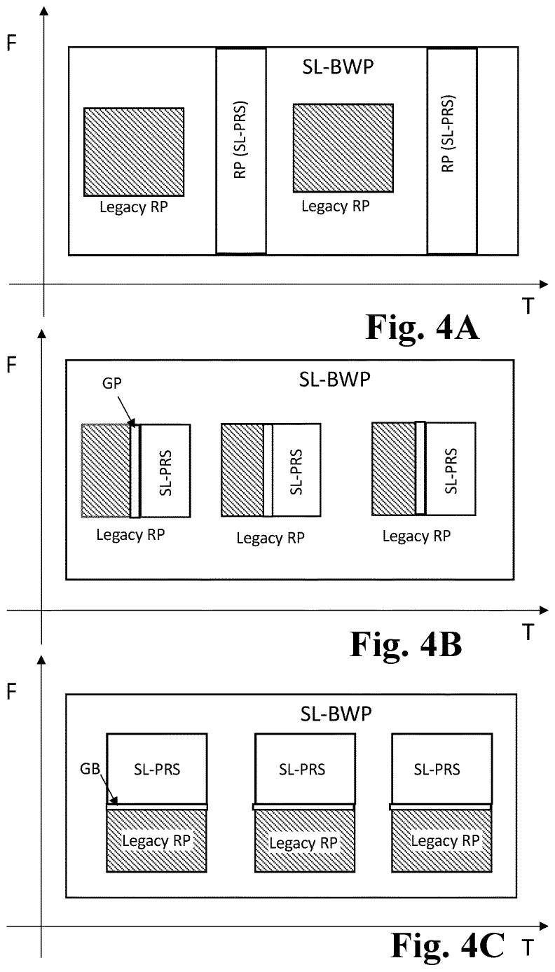

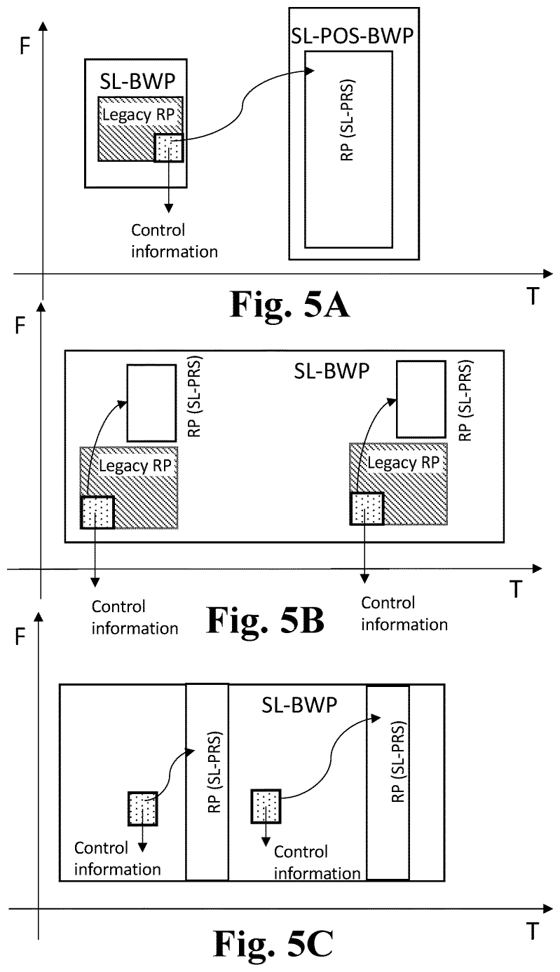

FIG. 3 illustrates a standard resource allocation for sidelink communication. The radio network node may define a set of allocated resources for UL transmission on the Uu interface. The sidelink resource pool is typically defined as part of the Uu UL spectrum. The WD may be configured with a bandwidth part for sidelink communication (SL-BWP) within the Uu UL spectrum. Within the SL-BWP, the WD can be configured with at least one resource pool. In FIG. 3, an example periodic resource pool allocation for the WD is illustrated, where the resource pool is repeated over time, such as with a certain periodicity. FIG. 4A-4C disclose example resource allocations for sidelink positioning, such as for transmission and/or reception of SL-PRS, according to this disclosure. For example, dedicated resources are introduced for SL-PRS transmission. This is unlike the legacy resource allocation for sidelink communication where common resources are to be used for multiple purposes and/or transmissions. In one or more example methods, such as shown in FIG. 4A, the dedicated resources for SL-PRS transmission may be a dedicated resource pool for SL-PRS transmission, herein referred to as RP (SL-PRS). This may be the case when SL-PRS transmission requires a wider bandwidth than the bandwidth for legacy sidelink communication. In one or more example methods, such as shown in FIGS. 4B and 4C, the dedicated resources for SL-PRS transmission can be allocated to a portion of a legacy resource pool for sidelink, in which the dedicated resources for SL-PRS are separated, for example by a guard period (GP), from the legacy resources for sidelink communication. The GP duration can be in one or more OFDM symbol(s). In one or more example methods according to this disclosure, the dedicated resources for SL-PRS may be separated in time, such as by means of the GP, from the legacy resources for sidelink communication, as shown in FIG. 4B. In one or more example methods according to this disclosure, the dedicated resources for SL-PRS may be separated in frequency from the legacy resources for sidelink communication, as shown in FIG. 4C. In one or more example methods, a guard band (GB) may separate the dedicated resources for SL-PRS from the legacy resources for sidelink in frequency. The GB can be in the order of one or more sub-carrier(s). As can be seen in the example resource allocations in FIG. 4A-4C, the dedicated resources for sidelink positioning may be allocated within a bandwidth part that has previously been allocated for legacy sidelink communication, such as the SL-BWP. In one or more example methods, the dedicated BWP may comprise resources that may have been previously used for the legacy resource pool. However, the dedicated resources for sidelink positioning may, in one or more example methods, be allocated within a dedicated bandwidth part for sidelink positioning, such as a bandwidth part separate from SL-BWP. FIGS. 5A-5C illustrate example allocations of control signaling for configuring a WD with dedicated resources for sidelink positioning according to the current disclosure. As can be seen in FIG. 5A, the WD can be configured with multiple BWPs for sidelink usage, such as a first BWP for legacy sidelink communication, in FIG. 5A referred to as SL-BWP and a second dedicated BWP for sidelink positioning, in FIG. 5A referred to as SL-POS-BWP.

The SL-POS-BWP may be dedicated for transmission and/or reception of SL-PRS. In legacy sidelink, a WD is only configured with one sidelink BWP. The solution according to the current disclosure thus differs from legacy sidelink in that the WD can be configured with a plurality of BWPs, such as with at least one SL-POS-BWP in addition to the SL-BWP, wherein at least one BWP may be dedicated for sidelink positioning. Only one BWP may be activated in a given time. The different BWPs may be associated with a respective BWP index. In one or more example methods, the WD may be configured with a plurality of SL-POS-BWPs having a respective BWP index, where each BWP index can be associated with a positioning accuracy. For example, a first BWP index, such as BWP index 1, may represent a narrow SL-POS-BWP, such as a SL-POS-BWP having lower positioning accuracy. A second BWP index, such as a higher index, such as a BWP index 2, may represent a wider SL-POS-BWP, such as a SL-POS-BWP having higher positioning accuracy. In order for the Rx WD to know where to monitor for SL-PRSs, control information, such as SCI, can be transmitted from the Tx WD to the Rx WD. The control information may comprise the dedicated sidelink positioning resource configuration which configures the Rx WD to monitor the dedicated sidelink positioning resources and/or dedicated sidelink positioning bandwidth part for SL-PRS. The control information may be transmitted prior to the dedicated sidelink positioning resources and/or dedicated sidelink positioning bandwidth part. In the example shown in FIG. 5A, the control information is allocated in the legacy sidelink resource pool in the legacy SL-BWP and comprises an indication to the dedicated sidelink positioning resources located in the dedicated sidelink positioning bandwidth part, such as the SL-POS-BWP. In the example shown in FIG. 5B, the control information is allocated in the legacy sidelink resource pool in the legacy SL-BWP and comprises an indication to the dedicated sidelink positioning resources located within the legacy SL-BWP but being separated from the legacy sidelink resource pool in frequency. In the example shown in FIG. 5C, both the control information and the dedicated sidelink positioning resources are allocated within the legacy SL-BWP. The control information may however be allocated separately from, such as outside, a legacy sidelink resource pool.

As is illustrated in FIG. 5A-5C the control information, such as the SCI, can be allocated in two different ways. In FIG. 5A, the control information is located, such as transmitted, in the sidelink communication BWP, such as in the SL-BWP, but comprises an indication indicative of the SL-PRS resource configuration in the dedicated sidelink positioning BWP, such as the SL-POS-BWP. The control information may be transmitted in the resource, such as in the resource pool, for sidelink communication. In the example shown in FIG. 5B, the control information, such as the SCI, and the configured SL-PRS resource are in the same BWP. The control information may be transmitted in the resource, such as in the resource pool, for sidelink communication. In the example shown in FIG. 5C, the control information, such as the SCI, is transmitted in the same SL-BWP as the dedicated resources for sidelink positioning, but outside the dedicated sidelink positioning resources and/or any resources for sidelink communication.

One or more of the example methods discussed in relation to FIGS. 5A-5C may be used in sidelink Mode 2 resource allocation.

The configuration of the dedicated resources, such as a dedicated resource pool, for SL-PRS can be provided in multiple levels or steps.

In one or more example methods, the WD may be provided with a first configuration, such as a dedicated sidelink positioning resource configuration. The dedicated sidelink positioning resource configuration may comprise properties and/or parameters of the dedicated resources for SL-PRS (such as of a resource pool configuration for SL-PRS monitoring). The dedicated sidelink positioning resource configuration may be conveyed, such as provided, to the WD using higher layer signaling, such as in an RRC message. The configuration may comprise one or more of:
Time properties, such as occupied symbols' indexes, and/or a repetition pattern for semi-persistent SL-PRS transmission.
Frequency properties, such as a location and/or size of the dedicated resources for SL-PRS. The frequency properties may for example comprise an offset of the SL-PRS band from the legacy sidelink resources or from the reference frequency point, and/or a physical resource block number. The offset may indicate the BWP's location in the resource pool. The offset may be indicated as an index (ID) of the first resource of the BWP.
A PRS allocation structure, such as a comb structure. The PRS allocation structure may be indicated as a comb type and a number of consecutive comb symbols, for example in a form such as: {Comb-k, I symbols}.

In one or more example methods, the first configuration may be transmitted by a resource allocating node, such as a positioning network node or a radio network node, such as a serving radio network node, to all WDs (such as to the Tx WD configured to transmit SL-PRS and the Rx WD configured to measure on received SL-PRS). This may for example be the case for groupcasting and unicasting scenarios.

In one or more example methods, the first configuration may be transmitted by a resource allocating node gNB to the Tx WD only. This may for example be the case for broadcasting scenarios.

In one or more example methods, the WD may be provided with a second configuration, such as a selected configuration of the dedicated resources for sidelink positioning, such as a granted and/or allocated resource for sidelink positioning, such as for transmission of SL-PRS. The selected configuration of the granted dedicated resources for sidelink positioning may be a selected configuration, such as a subset, out of the first configuration. The selected configuration of the granted dedicated resources for sidelink positioning can herein also be referred to as sidelink positioning resource activation configuration. The sidelink positioning resource activation configuration may be provided to the WD by a resource allocating node, such as a radio network node or a positioning network node, such as an LMF. The sidelink positioning resource activation configuration may be provided to the WD in a sidelink positioning resource activation message. The sidelink positioning resource activation configuration, such as the sidelink positioning resource activation message, may be conveyed using lower layer signaling, such as using DL Medium Access Control (MAC) Control Element (CE) or DL DCI. The sidelink positioning resource activation configuration may comprise one or more of:
An index of the selected configuration, such as of the second configuration. The index of the selected configuration such as the index of the SL-POS-BWP to be used for transmission of SL-PRS.
An indication indicative of an activation and/or deactivation of the granted dedicated resources for sidelink positioning.
A time duration (such as a number of instances) of the granted dedicated resources for sidelink positioning.
Deactivation of positioning resources.

In one or more example methods, the second configuration, such as the sidelink positioning resource activation configuration, may be conveyed, such as transmitted, from a serving radio network node to a Tx WD. The serving radio network node may be a resource allocating node allocating resources for sidelink transmission for the Tx WD. The Tx WD may be a WD configured to transmit and/or transmitting SL-PRS during a sidelink positioning procedure. The serving radio network node may transmit the second configuration to the Tx WD via lower layer signaling, such as via DCI.

In one or more example methods, the second configuration, such as the sidelink positioning resource activation configuration, may be conveyed, such as transmitted, from the Tx WD to the Rx WD, such as to a WD configured to receive or receiving SL-PRS during a sidelink positioning procedure. The Tx WD may for example forward the second configuration to the Rx WD upon receiving the second configuration from a serving radio network node. The Tx WD may transmit the second configuration to the Rx WD via SCI. In one or more example methods, the second configuration, such as the sidelink positioning resource activation configuration, may be conveyed separately from the dedicated resources for positioning.

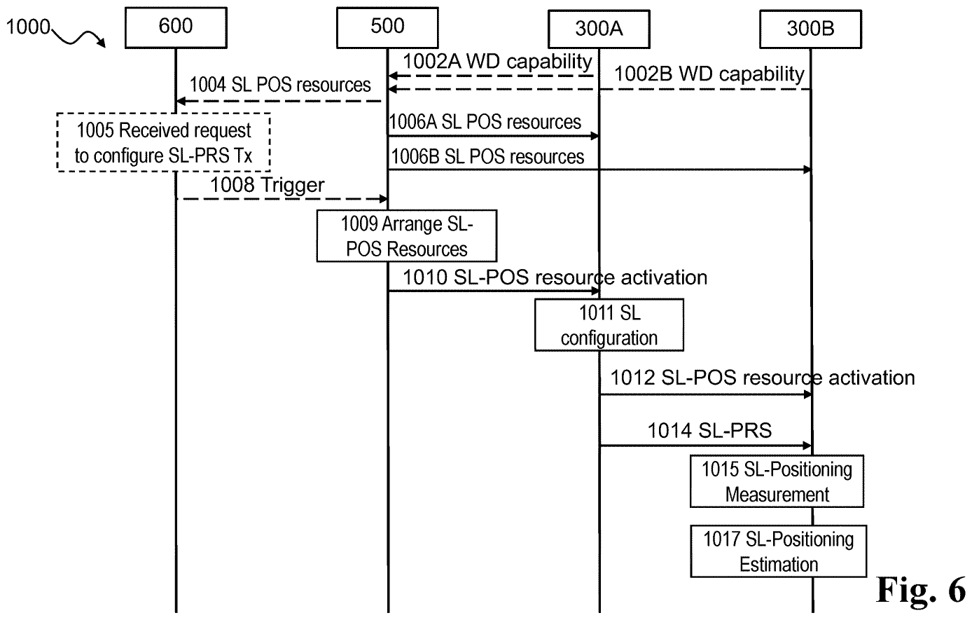

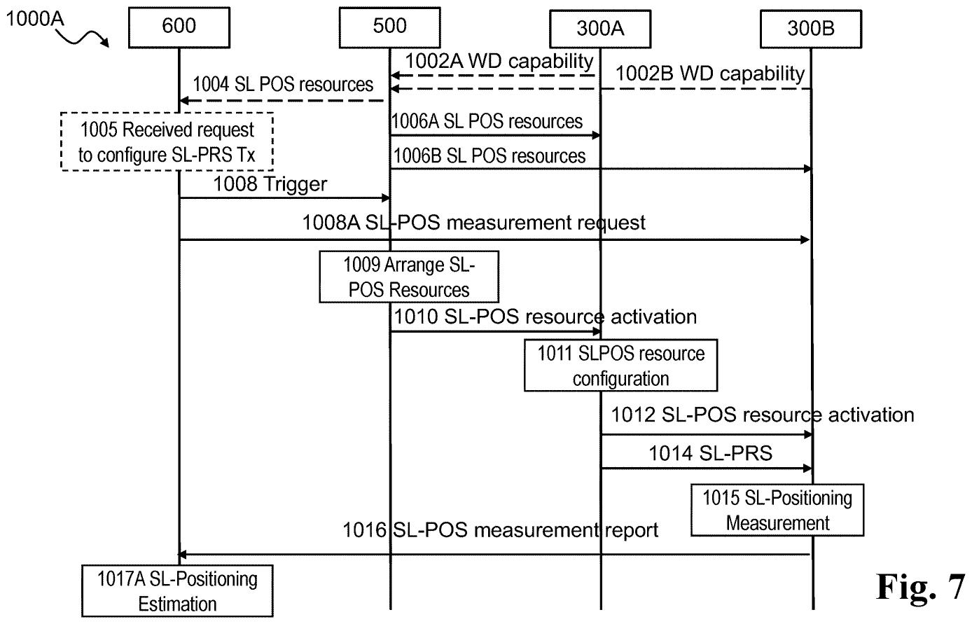

FIG. 6 and FIG. 7 illustrate example message exchanges between a first WD 300A, a second WD 300B, a resource allocating node 500, and a location network node 600, for configuring resources for sidelink positioning reference signal transmission. The first WD 300A may be an Rx WD being configured to receive PRSs during a sidelink positioning procedure. The second WD 300B may be a Tx WD being configured to transmit PRSs during a sidelink positioning procedure,

In the example message exchange illustrated in FIG. 6, a second WD 300B, such as a target WD, such as the WD that is to be positioned, performs both a positioning measurement 1015 (such as one or more of a timing measurement, a power measurement, and an angle measurement) and a positioning estimation 1017 (such as a relative and/or an absolute positioning). In the example shown in FIG. 6, the first WD 300A, such as an RSU of FIG. 1, transmits SL-PRS 1014, such as aperiodic SL-PRS, periodic SL-PRS or semi-persistent SL-PRS, so that the second WD 300B, such as the target WD, can use the SL-PRS for the positioning measurement 1015.

In one or more example methods, the first WD 300A and the second WD 300B, such as the WD configured to transmit SL PRS and the target WD, transmit their respective capabilities 1002A, 1002B to the resource allocating node 500. The capabilities 1002A, 1002B may comprise one or more of an indication indicative of the type of WD, such as whether the WD is an RSU, a VRU and/or a vehicle, an indication indicative of the WDs capability, such as the processing capability of the WD, and/or the antenna configuration of the WD. Based on capability, the resource allocating node 500 may identify the WD types (such as whether the respective WD is a vehicle, a VRU, or an RSU) and their respective capabilities (such as processing, antenna configuration, etc).

The resource allocating node 500 transmits a dedicated sidelink positioning resource configuration 1006A, 1006B to the first WD 300A and the second WD 300B respectively. The dedicated sidelink positioning resource configuration may be indicative of a dedicated sidelink positioning resource for transmission of SL PRS. The dedicated sidelink positioning resource configuration 1006A, 1006B may be transmitted using higher layer signaling, such as RRC signaling.

In one or more example methods, the resource allocating node 500 may provide the dedicated sidelink positioning resource configuration 1004 to the location network node 600, such as to the LMF. The location network node 600 may use this information in case the location network node 600 receives a request 1005 to activate and/or configure sidelink resources for positioning. The request 1005 may be received from an application residing in one or more of the wireless devices 300A, 300B. Upon the location network node 600 receiving a request to activate and/or configure sidelink resources for positioning, the location network node 600 may transmit a trigger 1008, to the resource allocating node 500, triggering the resource allocating node 500 to allocated sidelink PRS resources for the WDs 300A, 300B. Alternatively, the resource allocating node 500 may be configured directly by an operation node, such as an operation, administration maintenance (OAM) node, to activate sidelink resources for positioning.

The resource allocation node 500 may arrange SL-POS resources 1009 to be used for a positioning procedure over the sidelink between the first WD 300A and the second WD 300B, within the dedicated sidelink positioning resource configuration.

The resource allocation node 500 transmits to the first WD 300A, such as the WD configured to transmit SL-PRS, a sidelink positioning resource activation message 1010. The sidelink positioning resource activation message 1010 being indicative of a subset of the dedicated sidelink positioning resource being granted and/or allocated for sidelink positioning reference signal transmission. The sidelink positioning resource activation message 1010 may be indicative of a selection of the dedicated sidelink positioning resources to be used for SL-PRS transmission. The sidelink positioning resource activation message 1010 may trigger the first WD 300A to transmit the SL-PRS in the indicated subset of the dedicated sidelink positioning resource. The resource allocation node 500 may transmit the sidelink positioning resource activation message 1010 using lower layer signaling, such as using DCI.

The first WD 300A may apply 1011 the sidelink positioning resource configuration for transmission of SL-PRS. The first WD 300A may send a sidelink positioning resource activation message 1012 being indicative of a subset of the dedicated sidelink positioning resource being granted and/or allocated for sidelink positioning reference signal transmission to the second WD 300B. The sidelink positioning resource activation message 1012 may trigger the second WD to monitor the resources indicated in the sidelink positioning resource activation message 1012 for SL-PRS.

The first WD 300A may then transmit SL-PRS 1014 over the sidelink in the resources indicated in the sidelink positioning resource activation message 1010, such as in the subset of the dedicated sidelink positioning resource being granted and/or allocated for sidelink positioning reference signal transmission.

The second WD 300B performs sidelink positioning measurements 1015 on the SL-PRS 1014 transmitted by the first WD 300A.

Based on the sidelink positioning measurements 1015, the second WD 300B may perform a sidelink positioning estimation 1017 to estimate a position of a target WD, such as of the second WD 300B.

In the example message exchange illustrated in FIG. 7, the sidelink positioning measurement is initiated by the location network node 600, such as the LMF. The example message exchange according to FIG. 7 mainly corresponds to the example message exchange in FIG. 6 but differs from the example message exchange according to FIG. 6 in that the second WD 300B does not perform the positioning estimation. Instead, the second WD 300B receives a sidelink positioning request 1008A, from the location network node 600, requesting the second WD 300B to perform the sidelink positioning procedure. The second WD 300B further provides the result of the positioning measurement to the location network node 600 in a positioning measurement report 1016. The location network node 600 may then perform a positioning estimation 1017A (such as a relative and/or an absolute positioning) based on the positioning measurement report 1016. This may for example be the case when the first WD 300A transmits aperiodic SL-PRS where the SL-PRS is transmitted momentarily. The first WD 300A, such as the WD transmitting the SL-PRS, may be one or more of an RSU, a vehicle and a VRU.

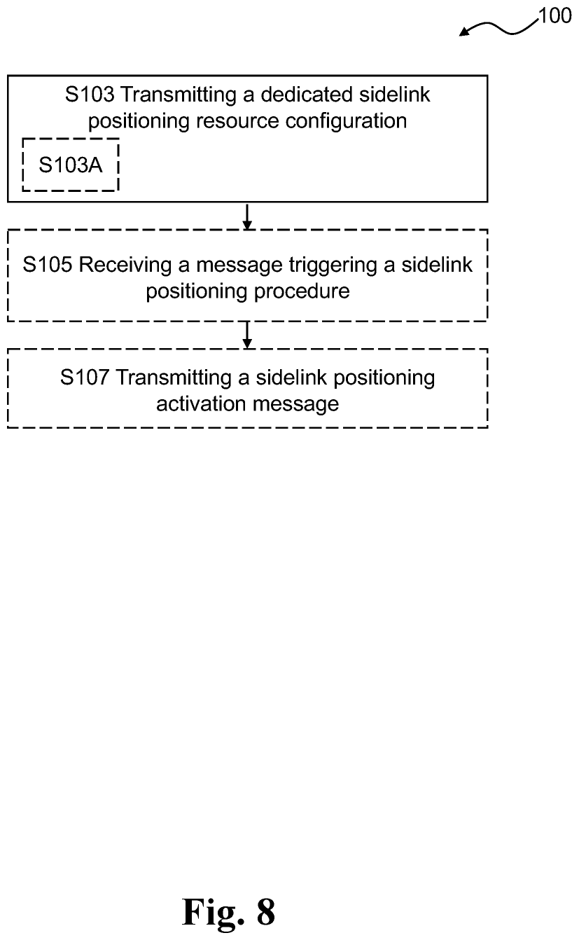

FIG. 8 shows a flow-chart of an example method 100, performed by a resource allocating node according to the disclosure, for configuring resources for sidelink positioning reference signal transmission. The resource allocating node is the resource allocating node disclosed herein, such as the radio network node 400 or a core network node 600, such as an LMF, of FIG. 1, FIG. 6, and FIG. 7.

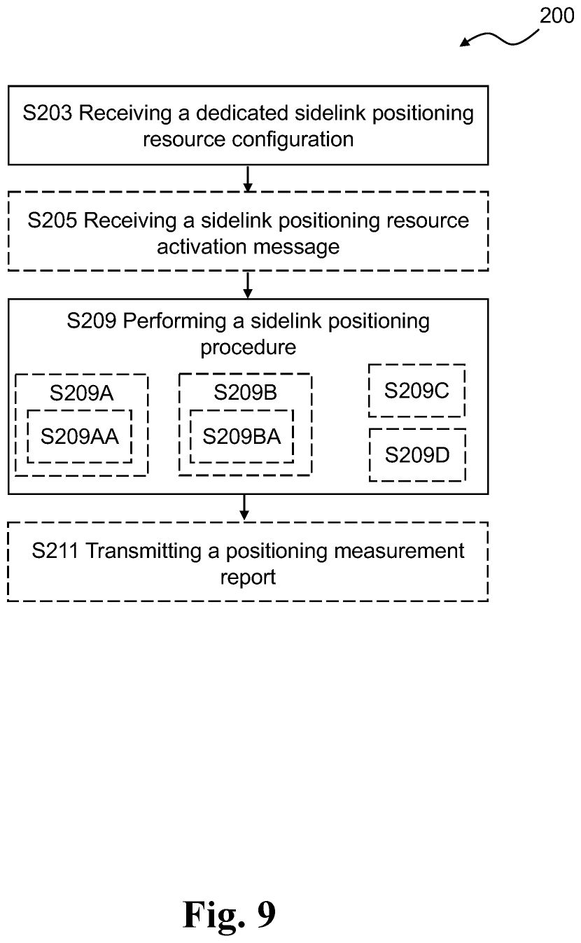

The method 100 comprises transmitting S103, to a WD, a dedicated sidelink positioning resource configuration. The WD may be a Tx WD, such as a WD being configured to transmit SL-PRS, and/or a Rx WD, such as a WD being configured to receive the SL-PRS transmitted by the Tx WD. The dedicated sidelink positioning resource configuration comprises an indication being indicative of a dedicated sidelink positioning resource, such as a dedicated set of sidelink positioning resources, such as a dedicated sidelink positioning resource pool, to be used by the WD during a sidelink positioning procedure. In one or more example methods, the dedicated sidelink positioning resource configuration is transmitted using higher layer signaling, such as RRC signaling. The dedicated sidelink positioning resource configuration may be transmitted upon the WD connecting to the network, such as to the resource allocating node. The dedicated sidelink positioning resource can herein be seen as a set of resources, such as a resource pool, being exclusive for SL-PRS transmissions. Step S103 described in relation to FIG. 8 corresponds to step S203 described in relation to FIGS. 9 and 1006A, 1006B of FIG. 6 and FIG. 7.

In one or more example methods, the dedicated sidelink positioning resource is separated from a resource for sidelink communication. Separated can herein be seen as the dedicated sidelink positioning resource not overlapping with any other sidelink resources, such as with the sidelink resource for communication. The resource for sidelink communication can be seen as a legacy resource for sidelink communication, such as a legacy resource pool for sidelink communication, such as a resource pool not exclusive for SL-PRS transmission. In other words, the dedicated sidelink positioning resource may be different than the resource for sidelink communication. The dedicated sidelink positioning resource may, in one or more example methods, be separated from the resource for sidelink communication in time. The dedicated sidelink positioning resource may for example be separated from the resource for sidelink communication by a guard period, such as a period of time. The purpose of the guard period is to avoid interference between the dedicated resource for sidelink positioning and the resource for sidelink communication. The dedicated sidelink positioning resource may, in one or more example methods, be separated from the resource for sidelink communication in frequency. In other words, the dedicated sidelink positioning resource and the resource for sidelink communication may be non-overlapping.

In one or more example methods, the indication indicative of the dedicated sidelink positioning resource is indicative of an index of one or more subsets of the dedicated sidelink positioning resource. The dedicated sidelink positioning resource may, in one or more example methods, comprise one or more subsets of the dedicated sidelink positioning resource which may be assigned a respective index. The indication may be indicative of the indexes of the one or more subsets that is available to the WD for SL-PRS transmission and/or reception.

In one or more example methods, the indication indicative of the dedicated sidelink positioning resource is indicative of a time property of the dedicated sidelink positioning resource. The time property may comprise one or more of an index of the symbols occupied by the dedicated sidelink positioning resource, a repetition pattern for SL-PRS transmission, such as semi-persistent SL-PRS transmission, and a time gap between the dedicated sidelink positioning resource and the resource for sidelink communication.

In one or more example methods, the indication indicative of the dedicated sidelink positioning resource is indicative of a frequency property of the dedicated sidelink positioning resource. The frequency property may be indicative of a size and location in frequency of the dedicated sidelink positioning resource, such as an offset of the dedicated sidelink positioning resource from the resource for sidelink communication, or a physical resource block number.

In one or more example methods, the indication indicative of the dedicated sidelink positioning resource is indicative of a PRS resource allocation structure. The PRS resource allocation structure may be a comb structure, which may be defined as comb type and number of consecutive comb symbols. The indication indicative of the dedicated sidelink positioning resource may indicate the PRS allocation structure in a form such as: {Comb-k, I symbols}, where “Comb-k” indicates the comb type and “I symbols” indicates the number of consecutive comb symbols. A comb structure can be seen as a distribution, such as a distribution pattern, of the occupied subcarriers given a specific occupancy density. The comb structure can in one or more example methods, be described by a comb offset and a comb size. The comb offset may determine the frequency shift of the occupied subcarriers in each symbol. The comb size may refer to the density of the occupied subcarrier in a given reference signal symbol. For example, a comb-2 structure means that PRS occupies every other subcarrier in a given symbol within the allocated bandwidth.

In one or more example methods, the indication indicative of the dedicated sidelink positioning resource is indicative of a bandwidth part or a frequency layer, such as one or more bandwidth parts or frequency layers, for the sidelink positioning procedure. In one or more example methods, the bandwidth part for the sidelink positioning procedure is different than a bandwidth part for sidelink communication. The resource allocating node may thus configure the WD with multiple bandwidth parts and/or frequency layers dedicated for transmission of SL-PRS. Only one of the configured bandwidth parts and/or frequency layers may be active at a time. The size of the bandwidth parts and/or frequency layers can be a function of the required positioning accuracy. For example, the bandwidth part and/or frequency layer may be larger when a high positioning accuracy is required and smaller when a lower position accuracy is required.

In one or more example methods, a bandwidth part or a frequency layer can be configured with one or more resource pool(s) for PRS transmission. In other words, a resource pool can be applied to one or more of the configured bandwidth parts or frequency layers, as long as the resource pool size is within the size of the bandwidth part or frequency layer. In other words, the dedicated sidelink positioning resource configuration, may indicate to the WD that certain resources, typically occurring with a certain periodicity, have been earmarked for the purpose of transmission of SL-PRS.

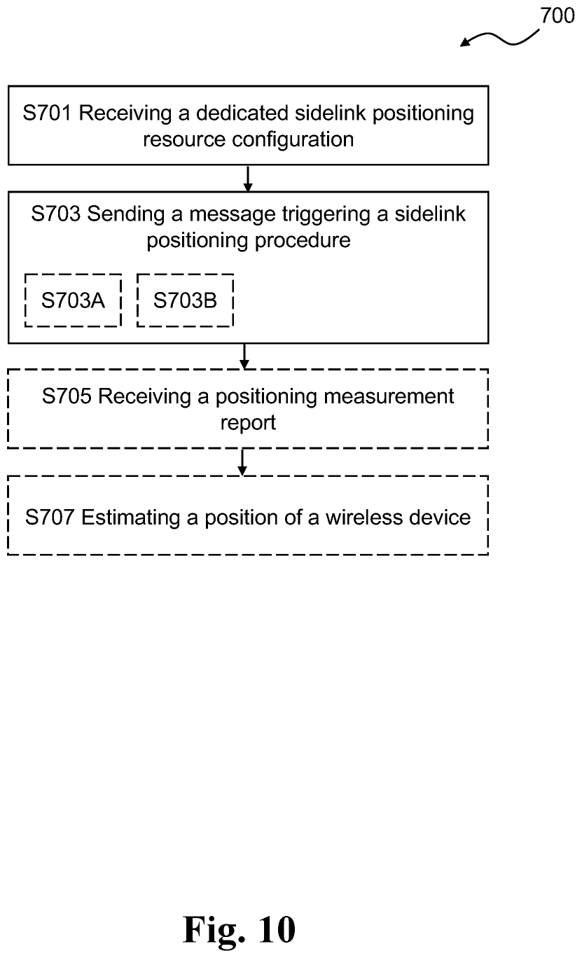

In one or more example methods, transmitting S103 comprises transmitting S103A the dedicated sidelink positioning resource configuration to a location network node, such as to an LMF. The location network node, such as the LMF, may use this information in case the location network node receives a request to activate and/or configure sidelink resources for positioning. Alternatively, the location network node is configured directly by the resource allocating node to activate sidelink resource for positioning. Step S103A described in relation to FIG. 8 corresponds to step S701 described in relation to FIGS. 10 and 1004 of FIG. 6 and FIG. 7.

In one or more example methods, the method 100 comprises receiving S105, from the location network node, a message triggering a sidelink positioning procedure in the available dedicated sidelink positioning resource. In one or more examples, the location network node, such as the LMF, may receive a request to configure sidelink positioning. The location network node may initiate the sidelink positioning by sending the message triggering a sidelink positioning procedure in the available dedicated sidelink positioning resource to the resource allocation node. Step S105 described in relation to FIG. 8 corresponds to step S703 described in relation to FIGS. 10 and 1008 of FIG. 6 and FIG. 7.

In one or more example methods, the method 100 comprises transmitting S107, to the WD, such as to an Tx WD or an Rx WD, a sidelink positioning resource activation message being indicative of a subset of the dedicated sidelink positioning resource being granted and/or allocated for sidelink positioning reference signal transmission. The subset of the dedicated sidelink positioning resource may be allocated to one or more WDs. Step S107 described in relation to FIG. 8 corresponds to step S205 described in relation to FIGS. 9 and 1010 of FIG. 6 and FIG. 7.

In one or more example methods, the sidelink positioning resource activation message is indicative of an index of a subset of the dedicated sidelink positioning resource being allocated for sidelink positioning reference signal transmission. In case the dedicated sidelink positioning resource comprises one or more subsets of resources assigned a respective index, the sidelink positioning resource activation message may comprise an indication being indicative of an index of the subset of the dedicated sidelink positioning resource granted and/or allocated for sidelink positioning reference signal transmission for the WD.

In one or more example methods, the sidelink positioning resource activation message is indicative of an activation and/or a deactivation of the dedicated sidelink positioning resource configuration, such as to a subset of the resources in the dedicated sidelink positioning resource configuration. In one or more example methods, the sidelink positioning resource activation message comprises a bandwidth part switching command instructing the WD to switch from and/or to the bandwidth part or the frequency layer for the sidelink positioning procedure to/from the bandwidth part or frequency layer for sidelink communication. In other words, the activation and/or the deactivation of the dedicated sidelink positioning resource configuration may in one or more example methods be indicated by the bandwidth part switching command.

In one or more example methods, the sidelink positioning resource activation message is indicative of a time duration, such as a number of instances, of the dedicated sidelink positioning resource configuration being allocated for sidelink positioning reference signal transmission. The time duration may for example be indicative of a number of instances that the resource for transmission of SL-PRS is repeated.

In one or more example methods, the sidelink positioning resource activation message is transmitted using lower layer signaling, such as via DCI and/or SCI. This may for example be the case for dynamic grant and/or for CG type 2 of the dedicated sidelink positioning resources.

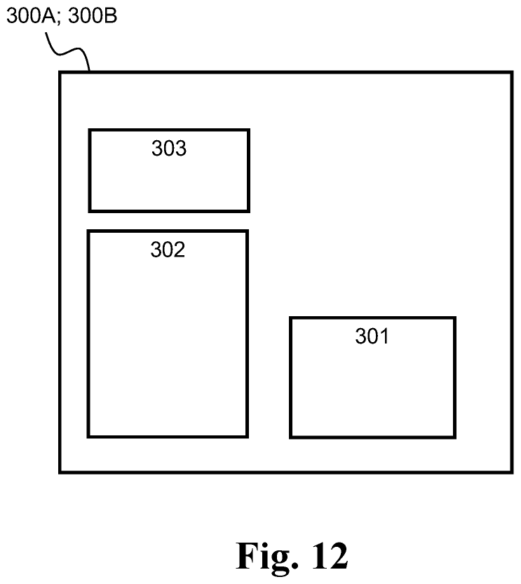

In one or more example methods, the sidelink positioning resource activation message is transmitted using higher layer signaling such as RRC signaling. This may for example be the case for CG type 1 of the dedicated sidelink positioning resources FIG. 9 shows a flow-chart of an example method 200, performed by a WD according to this disclosure, for configuring resources for sidelink positioning reference signal transmission. The WD is the WD disclosed herein, such as WD 300A, 300B of FIG. 1, FIG. 6, FIG. 7, and FIG. 12.

The method 200 comprises receiving S203, from a resource allocating node, a dedicated sidelink positioning resource configuration. The dedicated sidelink positioning resource configuration comprises an indication being indicative of a dedicated sidelink positioning resource, such as a dedicated set of sidelink positioning resources, such as a dedicated sidelink positioning resource pool, to be used by the WD during a sidelink positioning procedure. In one or more example methods, the dedicated sidelink positioning resource configuration is received using higher layer signaling, such as RRC signaling. The dedicated sidelink positioning resource configuration may be received upon the WD connecting to the network, such as to the resource allocating node. The dedicated sidelink positioning resource can herein be seen as a set of resources, such as a resource pool, being exclusive for SL-PRS transmissions. Step S203 described in relation to FIG. 9 corresponds to step S103 described in relation to FIG. 8, and 1006A, 1006B of FIG. 6 and FIG. 7.

In one or more example methods, the dedicated sidelink positioning resource is separated from a resource for sidelink communication. The resource for sidelink communication can be seen as a legacy resource for sidelink communication, such as a legacy resource pool for sidelink communication, such as a resource pool not exclusive for SL-PRS transmission. In other words, the dedicated sidelink positioning resource may be different than the resource for sidelink communication.

The dedicated sidelink positioning resource may, in one or more example methods, be separated from the resource for sidelink communication in time. The dedicated sidelink positioning resource may for example be separated from the resource for sidelink communication by a guard period, such as a period of time. The purpose of the guard period is to avoid interference between the dedicated resource for sidelink positioning and the resource for sidelink communication.

The dedicated sidelink positioning resource may, in one or more example methods, be separated from the resource for sidelink communication in frequency. In other words, the dedicated sidelink positioning resource and the resource for sidelink communication may be non-overlapping.

In one or more example methods, the indication indicative of the dedicated sidelink positioning resource is indicative of an index of one or more subsets of the dedicated sidelink positioning resource. The dedicated sidelink positioning resource may, in one or more example methods, comprise one or more subsets of the dedicated sidelink positioning resource which may be assigned a respective index. The indication may be indicative of the indexes of the one or more subsets that is available to the WD for SL-PRS transmission and/or reception.

In one or more example methods, the indication indicative of the dedicated sidelink positioning resource is indicative of a time property of the dedicated sidelink positioning resource. The time property may comprise one or more of an index of the symbols occupied by the dedicated sidelink positioning resource, a repetition pattern for SL-PRS transmission, such as semi-persistent SL-PRS transmission, and a time gap between the dedicated sidelink positioning resource and the resource for sidelink communication.

In one or more example methods, the indication indicative of the dedicated sidelink positioning resource is indicative of a frequency property of the dedicated sidelink positioning resource. The frequency property may be indicative of a size and location in frequency of the dedicated sidelink positioning resource, such as an offset of the dedicated sidelink positioning resource from the resource for sidelink communication, or a physical resource block number.

In one or more example methods, the indication indicative of the dedicated sidelink positioning resource is indicative of a PRS resource allocation structure. The PRS resource allocation structure may be a comb structure, which may be defined as comb type and number of consecutive comb symbols. The density of subcarrier occupied in a given PRS symbol is referred to comb size. The indication indicative of the dedicated sidelink positioning resource may indicate the PRS allocation structure in a form such as: {Comb-k, symbols}, where “Comb-k” indicates the comb type and “I symbols” indicates the number of consecutive comb symbols.

In one or more example methods, the indication indicative of the dedicated sidelink positioning resource is indicative of a bandwidth part or a frequency layer, such as one or more bandwidth parts or frequency layers, for the sidelink positioning procedure. In one or more example methods, the bandwidth part for the sidelink positioning procedure is different than a bandwidth part for sidelink communication. The resource allocating node may thus configure the WD with multiple bandwidth parts and/or frequency layers dedicated for transmission of SL-PRS. Only one of the configured bandwidth parts and/or frequency layers may be active at a time. The size of the bandwidth parts and/or frequency layers can be a function of the required positioning accuracy. For example, the bandwidth part and/or frequency layer may be larger when a high positioning accuracy is required and smaller when a lower position accuracy is required.

In one or more example methods, the method 200 comprises receiving S205, from the resource allocating node, a sidelink positioning resource activation message. In one or more example methods, the sidelink positioning resource activation message is indicative of a subset of the dedicated sidelink positioning resource being granted and/or allocated for sidelink positioning reference signal transmission. Step S205 described in relation to FIG. 9 corresponds to step S107 described in relation to FIG. 8, and 1010 of FIG. 6 and FIG. 7.

In one or more example methods, the sidelink positioning resource activation message is indicative of an index of a subset of the dedicated sidelink positioning resource being allocated for sidelink positioning reference signal transmission. In case the dedicated sidelink positioning resource comprises one or more subsets of resources assigned a respective index, the sidelink positioning resource activation message may comprise an indication being indicative of an index of the subset of the dedicated sidelink positioning resource granted and/or allocated for sidelink positioning reference signal transmission for the WD.

In one or more example methods, the sidelink positioning resource activation message is indicative of an activation and/or a deactivation of the dedicated sidelink positioning resource configuration, such as to a subset of the resources in the dedicated sidelink positioning resource configuration. In one or more example methods, the sidelink positioning resource activation message comprises a bandwidth part switching command instructing the WD to switch from and/or to the bandwidth part or the frequency layer for the sidelink positioning procedure to/from the bandwidth part or frequency layer for sidelink communication. In other words, the activation and/or the deactivation of the dedicated sidelink positioning resource configuration may in one or more example methods be indicated by the bandwidth part switching command.

In one or more example methods, the sidelink positioning resource activation message is indicative of a time duration, such as a number of instances, of the dedicated sidelink positioning resource configuration being allocated for sidelink positioning reference signal transmission. The time duration may for example be indicative of a number of instances that the resource for transmission of SL-PRS is repeated.

In one or more example methods, the sidelink positioning resource activation message is received using lower layer signaling, such as via DCI and/or SCI. This may for example be the case for dynamic grant and/or for CG type 2 of the dedicated sidelink positioning resources.

In one or more example methods, the sidelink positioning resource activation message is received using higher layer signaling such as RRC signaling. This may for example be the case for CG type 1 of the dedicated sidelink positioning resources

The method 200 comprises performing S209 a sidelink positioning procedure based on sidelink positioning reference signals transmitted in the dedicated sidelink positioning resource, such as in the subset of the dedicated sidelink positioning resource being granted and/or allocated for sidelink positioning reference signal transmission. Step S209 described in relation to FIG. 9 is similar to 1014, 1015, 1016, and/or 1017 of FIG. 6 and FIG. 7.

In one or more example methods, such as when the WD is a sidelink reference signal transmitting WD, performing S209 comprises transmitting S209A, to a sidelink reference signal receiving WD, sidelink positioning reference signals on the indicated dedicated sidelink positioning resource. Step S209A described in relation to FIG. 9 corresponds to 1014 of FIG. 6 and FIG. 7.

In one or more example methods, transmitting S209A comprises transmitting S209AA the sidelink positioning reference signals on the indicated subset dedicated sidelink positioning resource.

In one or more example methods, such as when the WD is a sidelink reference signal receiving WD. In one or more example methods, performing S209 comprises receiving S209B, from the sidelink reference signal transmitting WD, sidelink positioning reference signals on the indicated dedicated sidelink positioning resource. In one or more example methods, receiving S209B comprises receiving S209BA the sidelink positioning reference signals on the indicated subset dedicated sidelink positioning resource. Step S209B described in relation to FIG. 9 corresponds to 1014 of FIG. 6 and FIG. 7.

In one or more example methods, performing S209 comprises performing S209C a positioning measurement based on the received sidelink positioning reference signals. Step S209C described in relation to FIG. 9 corresponds to 1015 of FIG. 6 and FIG. 7.

In one or more example methods, performing S209 comprises estimating S209D a position of the transmitting WD based on the performed positioning measurement. Estimating S209D the position may comprise one or more of ranging, relative positioning, and absolute positioning of the WD as defined in 3GPP Rel 18. Step S209D described in relation to FIG. 9 corresponds to 1017 of FIG. 6.

In one or more example methods, the method 200 comprises transmitting S211, to a location network node, a positioning measurement report. The positioning measurement report may comprise the measurement result of the performed positioning measurement. Step S211 described in relation to FIG. 9 corresponds to 1016 of FIG. 7.

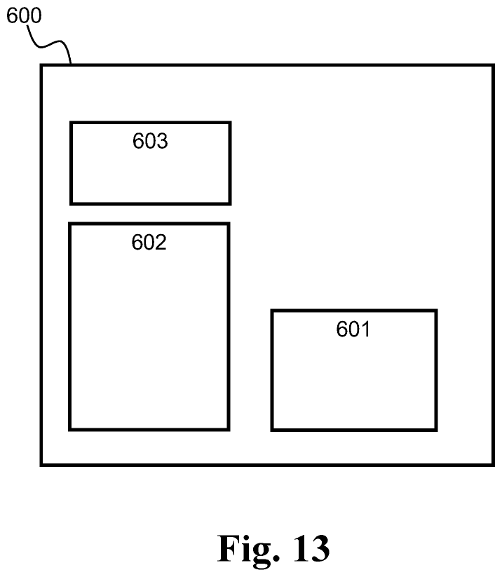

FIG. 10 shows a flow-chart of an example method 700, performed by a location network node, according to the disclosure, for handling sidelink positioning. The location network node is the location network node disclosed herein, such as location network node 600 of FIG. 1, FIG. 6, FIG. 7 and FIG. 13, such as an LMF.

The method 700 comprises receiving S701, from a resource allocating node, a dedicated sidelink positioning resource configuration. The dedicated sidelink positioning resource configuration comprises an indication being indicative of a dedicated sidelink positioning resource to be used by a wireless device, WD, during a sidelink positioning procedure. The dedicated sidelink positioning resource configuration comprises an indication being indicative of a dedicated sidelink positioning resource, such as a dedicated set of sidelink positioning resources, such as a dedicated sidelink positioning resource pool, to be used by the WD during a sidelink positioning procedure. In one or more example methods, the dedicated sidelink positioning resource configuration is transmitted using higher layer signaling, such as RRC signaling. The dedicated sidelink positioning resource can herein be seen as a set of resources, such as a resource pool, being exclusive for SL-PRS transmissions. The location network node may use this information in case the location network node receives a request to activate and/or configure sidelink resources for positioning. Alternatively, the location network node may be configured directly by the resource allocating node to activate sidelink resource for positioning. Step S701 described in relation to FIG. 10 corresponds to step S103A described in relation to FIG. 8, and to 1004 of FIG. 6 and FIG. 7.

The method 700 comprises sending S703, to the resource allocating node, a message triggering a sidelink positioning procedure in the dedicated sidelink positioning resource. In one or more examples, the location network node, such as the LMF, may receive a request to configure sidelink positioning. The location network node may initiate the sidelink positioning by sending the message triggering a sidelink positioning procedure in the available dedicated sidelink positioning resource to the resource allocation node. Step S703 described in relation to FIG. 10 corresponds to step S105 described in relation to FIG. 8, and to 1008 of FIG. 6 and FIG. 7.

In one or more example methods, sending S703 comprises sending S703A, to a radio network node, a message triggering the radio network node to allocate a subset out of the dedicated sidelink positioning resources, for transmission of sidelink positioning reference signals. The radio network node may be the resource allocating node for the sidelink.

In one or more example methods, sending S703 comprises sending S703B, to the WD, a message triggering the WD to perform a sidelink positioning measurement. The message may for example be a positioning measurement request. Step S703B described in relation to FIG. 10 corresponds to 1008A of FIG. 7.

In one or more example methods, the method 700 comprises receiving S705, from the WD, a positioning measurement report. The positioning measurement report may comprise the measurement result of a positioning measurement performed by the WD. Step S705 described in relation to FIG. 10 corresponds to 1016 of FIG. 7.

In one or more example methods, the method 700 comprises estimating S707 a position of the WD based on the positioning measurement report. Estimating S707 the position may comprise one or more of ranging, relative positioning, and absolute positioning of the WD as defined in 3GPP Rel 18. Step S707 described in relation to FIG. 10 corresponds to 1017A of FIG. 7.

In one or more example methods, the indication indicative of the dedicated sidelink positioning resource is indicative of one or more of: a time property for sidelink positioning reference signal transmission, a frequency property for sidelink positioning reference signal transmission, and a positioning reference signal resource allocation structure.

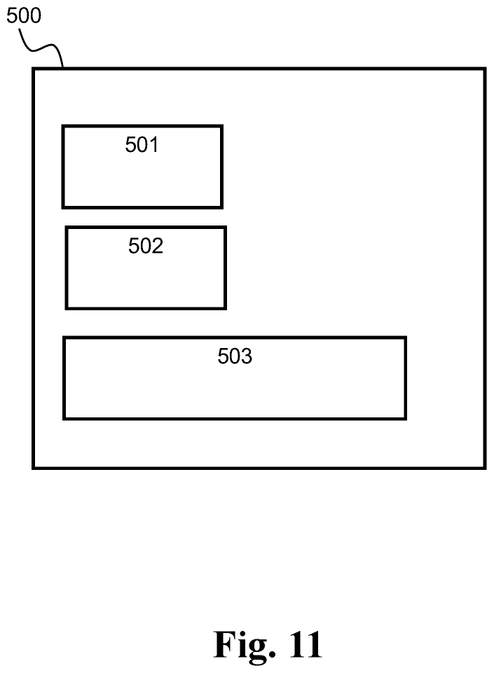

FIG. 11 shows a block diagram of an example resource allocating node 500 according to the disclosure. The resource allocating node 500 comprises memory circuitry 501, processor circuitry 502, and an interface 503, such as a wired and/or wireless interface. The resource allocating node 500 may be configured to perform any of the methods disclosed in FIG. 8. In other words, the resource allocating node 500 may be configured for configuring resources for sidelink positioning reference signal transmission. The resource allocating node may be the resource allocating node of FIG. 6, and FIG. 7, such as a radio network node, such as radio network node 400 of FIG. 1 or a core network node, such as core network node 600 of FIG. 1.

The resource allocating node 500 is configured to communicate with a wireless device, WD, such as the WD disclosed herein, and/or a location network node, using a wireless communication system.

The wireless interface 503 is configured for wireless communications via a wireless communication system, such as a 3GPP system, such as a 3GPP system supporting one or more of: New Radio, Long Term Evolution, LTE, NR, Narrow-band IoT, NB-IoT, and Long Term Evolution-enhanced Machine Type Communication, LTE-M, 3GPP system operated in licensed bands or unlicensed bands.

The resource allocating node 500 is configured to transmit, for example, via the interface 503, to the WD, a dedicated sidelink positioning resource configuration. The dedicated sidelink positioning resource configuration comprises an indication being indicative of a dedicated sidelink positioning resource to be used by the WD during a sidelink positioning procedure.

Processor circuitry 502 is optionally configured to perform any of the operations disclosed in FIG. 8 (such as any one or more of S103, S103A, S105, S107). The operations of the resource allocating node 500 may be embodied in the form of executable logic routines (for example, lines of code, software programs, etc.) that are stored on a non-transitory computer readable medium (for example, memory circuitry 501) and are executed by processor circuitry 502.

Furthermore, the operations of the resource allocating node 500 may be considered a method that the resource allocating node 500 is configured to carry out. Also, while the described functions and operations may be implemented in software, such functionality may also be carried out via dedicated hardware or firmware, or some combination of hardware, firmware and/or software.

Memory circuitry 501 may be one or more of a buffer, a flash memory, a hard drive, a removable media, a volatile memory, a non-volatile memory, a random access memory (RAM), or other suitable device. In a typical arrangement, memory circuitry 501 may include a non-volatile memory for long term data storage and a volatile memory that functions as system memory for processor circuitry 502. Memory circuitry 501 may exchange data with processor circuitry 502 over a data bus. Control lines and an address bus between memory circuitry 501 and processor circuitry 502 also may be present (not shown in FIG. 11). Memory circuitry 501 is considered a non-transitory computer readable medium.

Memory circuitry 501 may be configured to store the dedicated sidelink positioning resource configuration, and/or a subset of the dedicated sidelink positioning resource configuration, in a part of the memory.

FIG. 12 shows a block diagram of an example wireless device 300A, 300B according to the disclosure. The wireless device 300A, 300B comprises memory circuitry 301, processor circuitry 302, and a wireless interface 303. The wireless device 300A, 300B may be configured to perform any of the methods disclosed in FIG. 9. In other words, the wireless device 300A, 300B may be configured for configuring resources for sidelink positioning reference signal transmission.

The WD 300A, 300B is configured to communicate with a resource allocating node, such as the resource allocating node disclosed herein, using a wireless communication system. The WD 300A, 300B is configured to receive (such as via the wireless interface 303), from a resource allocating node, a dedicated sidelink positioning resource configuration. The dedicated sidelink positioning resource configuration comprises an indication being indicative of a dedicated sidelink positioning resource to be used by the WD during a sidelink positioning procedure.

The WD 300A, 300B is configured to perform (such as via the wireless interface 303 and/or using the processor circuitry 302) a sidelink positioning procedure based on sidelink positioning reference signals transmitted in the dedicated sidelink positioning resource.

The wireless interface 303 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, 3GPP system operated in licensed bands or unlicensed bands.

The WD 300A, 300B is optionally configured to perform any of the operations disclosed in FIG. 9 (such as any one or more of S203, S205, S209, S209A, S209AA, S209B, S209BA, S209C, S209D, S211). The operations of the WD 300 may be embodied in the form of executable logic routines (for example, lines of code, software programs, etc.) that are stored on a non-transitory computer readable medium (for example, memory circuitry 301) and are executed by processor circuitry 302.

Furthermore, the operations of the WD 300A, 300B may be considered a method that the WD 300A, 300B is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 12). Memory circuitry 301 is considered a non-transitory computer readable medium.

Memory circuitry 301 may be configured to store the dedicated sidelink positioning resource configuration, and/or a subset of the dedicated sidelink positioning resource configuration, in a part of the memory.

FIG. 13 shows a block diagram of an example location network node 600 according to the disclosure. The location network node 600 comprises memory circuitry 601, processor circuitry 602, and an interface 603, such as a wired and/or wireless interface. The location network node 600 may be configured to perform any of the methods disclosed in FIG. 10. In other words, the location network node 600 may be configured for handling sidelink positioning.

The location network node 600 is configured to communicate with a resource allocating node, such as the resource allocating node disclosed herein, using a wireless communication system.

The interface 603 is configured for wireless communications via a wireless communication system, such as a 3GPP system, such as a 3GPP system supporting one or more of: New Radio, NR, Long Term Evolution, LTE, Narrow-band IoT, NB-IOT, and Long Term Evolution -enhanced Machine Type Communication, LTE-M, 3GPP system operated in licensed bands or unlicensed bands.

The location network node 600 is configured to receive, for example, via the interface 603, from the resource allocating node, a dedicated sidelink positioning resource configuration. The dedicated sidelink positioning resource configuration comprises an indication being indicative of a dedicated sidelink positioning resource to be used by a wireless device, WD, during a sidelink positioning procedure.

The location network node 600 is configured to send, for example, via the interface 603, to the resource allocating node, a message triggering a sidelink positioning procedure in the dedicated sidelink positioning resource.

Processor circuitry 602 is optionally configured to perform any of the operations disclosed in FIG. 10 (such as any one or more of S701, S703, S703A, S703B, S705, S707). The operations of the location network node 600 may be embodied in the form of executable logic routines (for example, lines of code, software programs, etc.) that are stored on a non-transitory computer readable medium (for example, memory circuitry 601) and are executed by processor circuitry 602).

Furthermore, the operations of the location network node 600 may be considered a method that the location network node 600 is configured to carry out. Also, while the described functions and operations may be implemented in software, such functionality may also be carried out via dedicated hardware or firmware, or some combination of hardware, firmware and/or software.

Memory circuitry 601 may be one or more of a buffer, a flash memory, a hard drive, a removable media, a volatile memory, a non-volatile memory, a random access memory (RAM), or other suitable device. In a typical arrangement, memory circuitry 601 may include a non-volatile memory for long term data storage and a volatile memory that functions as system memory for processor circuitry 602. Memory circuitry 601 may exchange data with processor circuitry 602 over a data bus. Control lines and an address bus between memory circuitry 601 and processor circuitry 602 also may be present (not shown in FIG. 13). Memory circuitry 601 is considered a non-transitory computer readable medium.

Memory circuitry 601 may be configured to store the dedicated sidelink positioning resource configuration, and/or a subset of the dedicated sidelink positioning resource configuration, a part of the memory.

Examples of methods and products (network node and wireless device) according to the disclosure are set out in the following items:
Item 1. A method, performed by a resource allocating node, for configuring resources for sidelink positioning reference signal transmission, the method comprising:
   transmitting (S103), to a wireless device, WD, a dedicated sidelink positioning resource configuration, wherein the dedicated sidelink positioning resource configuration comprises an indication being indicative of a dedicated sidelink positioning resource to be used by the WD during a sidelink positioning procedure.
Item 2. The method according to Item 1, wherein the dedicated sidelink positioning resource is separated from a resource for sidelink communication.
Item 3. The method according to Item 2, wherein the dedicated sidelink positioning resource is separated from the resource for sidelink communication in time.
Item 4. The method according to Item 2 or 3, wherein the dedicated sidelink positioning resource is separated from the resource for sidelink communication in frequency.
Item 5. The method according to any one of the previous Items, wherein the indication indicative of the dedicated sidelink positioning resource is indicative of one or more of:
   an index of one or more subsets of the dedicated sidelink positioning resource,
   a time property of the dedicated sidelink positioning resource,
   a frequency property of the dedicated sidelink positioning resource, and
   a positioning reference signal resource allocation structure.
Item 6. The method according to any one of the previous Items, wherein the indication indicative of the dedicated sidelink positioning resource is indicative of a bandwidth part for the sidelink positioning procedure, wherein the bandwidth part for the sidelink positioning procedure is different than a bandwidth part for sidelink communication.
Item 7. The method according to any one of the previous Items, wherein the method comprises:
   transmitting (S107), to the WD, a sidelink positioning resource activation message, wherein the sidelink positioning resource activation message is indicative of a subset of the dedicated sidelink positioning resource being allocated for sidelink positioning reference signal transmission.
Item 8. The method according to Item 7, wherein the sidelink positioning resource activation message is indicative of one or more of:
   an index of a subset of the dedicated sidelink positioning resource being allocated for sidelink positioning reference signal transmission,
   an activation and/or a deactivation of the dedicated sidelink positioning resource configuration, and
   a time duration of the dedicated sidelink positioning resource configuration being allocated for sidelink positioning reference signal transmission.
Item 9. The method according to any one of the previous Items, wherein the resource allocating node is a radio network node.
Item 10. The method according to Item 9, wherein transmitting (S103) comprises transmitting (S103A) the dedicated sidelink positioning resource configuration to a location network node.
Item 11. The method according to Item 10, wherein the method comprises receiving (S105), from the location network node, a message triggering a sidelink positioning procedure in the available dedicated sidelink positioning resource.
Item 12. A method, performed by a wireless device, WD, for configuring resources for sidelink positioning reference signal transmission, the method comprising:
   receiving (S203), from a resource allocating node, a dedicated sidelink positioning resource configuration, wherein the dedicated sidelink positioning resource configuration comprises an indication being indicative of a dedicated sidelink positioning resource to be used by the WD during a sidelink positioning procedure, and
   performing (S209) a sidelink positioning procedure based on sidelink positioning reference signals transmitted in the dedicated sidelink positioning resource.
Item 13. The method according to Item 12, wherein the dedicated sidelink positioning resource is separated from a resource for sidelink communication.
Item 14. The method according to Item 13, wherein the dedicated sidelink positioning resource is separated from the resource for sidelink communication in time.
Item 15. The method according to Item 13 or 14, wherein the dedicated sidelink positioning resource is separated from the resource for sidelink communication in frequency.
Item 16. The method according to any one of the Items 12 to 15, wherein the indication indicative of the dedicated sidelink positioning resource is indicative of one or more of:
   an index of one or more subsets of the dedicated sidelink positioning resource,
   a time property of the dedicated sidelink positioning resource,
   a frequency property of the dedicated sidelink positioning resource, and
   a positioning reference signal resource allocation structure.
Item 17. The method according to any one of the Items 12 to 16, wherein the indication indicative of the dedicated sidelink positioning resource is indicative of a bandwidth part for the sidelink positioning procedure, wherein the bandwidth part for the sidelink positioning procedure is different than a bandwidth part for sidelink communication.
Item 18. The method according to any one of the Items 12 to 17, wherein the method comprises:
   receiving (S205), from the resource allocating node, a sidelink positioning resource activation message, wherein the sidelink positioning resource activation message is indicative of a subset of the dedicated sidelink positioning resource being allocated for sidelink positioning reference signal transmission.
Item 19. The method according to Item 18, wherein the sidelink positioning resource activation message is indicative of one or more of:
   an index of a subset of the dedicated sidelink positioning resource being allocated for sidelink positioning reference signal transmission, an activation and/or a deactivation of the dedicated sidelink positioning resource configuration, and
   a time duration of the dedicated sidelink positioning resource configuration being allocated for sidelink positioning reference signal transmission.
Item 20. The method according to any one of the Items 12 to 19, wherein the WD is a sidelink reference signal transmitting WD, and wherein performing (S209) comprises:
   transmitting (S209A), to a sidelink reference signal receiving WD, sidelink positioning reference signals on the indicated dedicated sidelink positioning resource.
Item 21. The method according to Item 20 and any one of Items 18 or 19, wherein transmitting (S209A) comprises transmitting (S209AA) the sidelink positioning reference signals on the indicated subset dedicated sidelink positioning resource.
Item 22. The method according to any one of the Items 12 to 19, wherein the WD is a sidelink reference signal receiving WD, and wherein performing (S209) comprises:
   receiving (S209B), from the sidelink reference signal transmitting WD, sidelink positioning reference signals on the indicated dedicated sidelink positioning resource, and
   performing (S209C) a positioning measurement based on the received sidelink positioning reference signals.
Item 23. The method according to Item 22 and any one of Items 18 or 19, wherein receiving (S209B) comprises receiving (S209BA) the sidelink positioning reference signals on the indicated subset dedicated sidelink positioning resource.
Item 24. The method according to any one of the Items 22 to 23, wherein performing (S209) comprises estimating (S209D) a position of the transmitting WD based on the performed positioning measurement.
Item 25. The method according to any one of the Items 12 to 24, the method comprising:
   transmitting (S211), to a location network node, a positioning measurement report.
Item 26. A method performed by a location network node, for handling sidelink positioning, wherein the method comprises:
   receiving (S701), from a resource allocating node, a dedicated sidelink positioning resource configuration, wherein the dedicated sidelink positioning resource configuration comprises an indication being indicative of a dedicated sidelink positioning resource to be used by a wireless device, WD, during a sidelink positioning procedure, and
   sending (S703), to the resource allocating node, a message triggering a sidelink positioning procedure in the dedicated sidelink positioning resource.
Item 27. The method according to Item 26, wherein sending (S703) comprises sending (S703A), to a radio network node, a message triggering the radio network node to allocate a subset out of the dedicated sidelink positioning resources, for transmission of sidelink positioning reference signals.
Item 28. The method according to Item 26 or 27, wherein sending (S703) comprises sending (S703B), to the WD, a message triggering the WD to perform a sidelink positioning measurement.
Item 29. The method according to Item 28, wherein the method comprises:
   receiving (S705), from the WD, a positioning measurement report.
Item 30. The method according to any one of Items 29, wherein the method comprises:
   estimating (S707), based on the positioning measurement report, a position of the WD.
Item 31. The method according to Item 26 to 30, wherein the indication being indicative of the dedicated sidelink positioning resource is indicative of one or more of:
   a time property for sidelink positioning reference signal transmission,
   a frequency property for sidelink positioning reference signal transmission, and
   a positioning reference signal resource allocation structure.
Item 32. A resource allocating node comprising memory circuitry, processor circuitry, and a wireless interface, wherein the resource allocating node is configured to perform any of the methods according to any of Items 1-11.
Item 33. A wireless device comprising memory circuitry, processor circuitry, and a wireless interface, wherein the wireless device is configured to perform any of the methods according to any of Items 12-25.
Item 34. A location network node comprising memory circuitry, processor circuitry, and a wireless interface, wherein the location network node is configured to perform any of the methods according to any of Items 26-31.

The use of the terms “first”, “second”, “third” and “fourth”, “primary”, “secondary”, “tertiary” etc. does not imply any particular order, but are included to identify individual elements.

Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-13 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented.

Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a resource allocating node, for configuring resources for sidelink positioning reference signal transmission, the method comprising:
transmitting to a wireless device (WD), a dedicated sidelink positioning resource configuration, wherein the dedicated sidelink positioning resource configuration comprises an indication being indicative of a dedicated sidelink positioning resource to be used by the WD during a sidelink positioning procedure.

2. The method according to claim 1, wherein the dedicated sidelink positioning resource is separated from a resource for sidelink communication.

3. The method according to claim 2, wherein the dedicated sidelink positioning resource is separated from the resource for sidelink communication in time.

4. The method according to claim 2, wherein the dedicated sidelink positioning resource is separated from the resource for sidelink communication in frequency.

5. The method according to claim 1, wherein the indication indicative of the dedicated sidelink positioning resource is indicative of one or more of: an index of one or more subsets of the dedicated sidelink positioning resource,
a time property of the dedicated sidelink positioning resource,
a frequency property of the dedicated sidelink positioning resource, and
a positioning reference signal resource allocation structure.

6. The method according to claim 1, wherein the indication indicative of the dedicated sidelink positioning resource is indicative of a bandwidth part for the sidelink positioning procedure, wherein the bandwidth part for the sidelink positioning procedure is different than a bandwidth part for sidelink communication.

7. The method according to claim 1, wherein the method comprises:
transmitting, to the WD, a sidelink positioning resource activation message, wherein the sidelink positioning resource activation message is indicative of a subset of the dedicated sidelink positioning resource being allocated for sidelink positioning reference signal transmission.

8. The method according to claim 7, wherein the sidelink positioning resource activation message is indicative of one or more of:
an index of a subset of the dedicated sidelink positioning resource being allocated for sidelink positioning reference signal transmission,
an activation and/or a deactivation of the dedicated sidelink positioning resource configuration, and
a time duration of the dedicated sidelink positioning resource configuration being allocated for sidelink positioning reference signal transmission.

9. The method according to claim 1, wherein the resource allocating node is a radio network node.

10. The method according to claim 9 wherein transmitting comprises transmitting the dedicated sidelink positioning resource configuration to a location network node.

11. The method according to claim 10, wherein the method comprises receiving from the location network node, a message triggering a sidelink positioning procedure in the available dedicated sidelink positioning resource.

12. A method, performed by a wireless device (WD) for configuring resources for sidelink positioning reference signal transmission, the method comprising:
receiving, from a resource allocating node, a dedicated sidelink positioning resource configuration, wherein the dedicated sidelink positioning resource configuration comprises an indication being indicative of a dedicated sidelink positioning resource to be used by the WD during a sidelink positioning procedure, and
performing a sidelink positioning procedure based on sidelink positioning reference signals transmitted in the dedicated sidelink positioning resource.

13. The method according to claim 12, wherein the dedicated sidelink positioning resource is separated from a resource for sidelink communication.

14. The method according to claim 13, wherein the dedicated sidelink positioning resource is separated from the resource for sidelink communication in time.

15. The method according to claim 13, wherein the dedicated sidelink positioning resource is separated from the resource for sidelink communication in frequency.

16. The method according to claim 12, wherein the indication indicative of the dedicated sidelink positioning resource is indicative of one or more of:
an index of one or more subsets of the dedicated sidelink positioning resource,
a time property of the dedicated sidelink positioning resource,
a frequency property of the dedicated sidelink positioning resource, and
a positioning reference signal resource allocation structure.

17. The method according to claim 12, wherein the indication indicative of the dedicated sidelink positioning resource is indicative of a bandwidth part for the sidelink positioning procedure, wherein the bandwidth part for the sidelink positioning procedure is different than a bandwidth part for sidelink communication.

18. The method according to claim 12, wherein the method comprises:
receiving, from the resource allocating node, a sidelink positioning resource activation message, wherein the sidelink positioning resource activation message is indicative of a subset of the dedicated sidelink positioning resource being allocated for sidelink positioning reference signal transmission.

19. The method according to claim 18, wherein the sidelink positioning resource activation message is indicative of one or more of:
an index of a subset of the dedicated sidelink positioning resource being allocated for sidelink positioning reference signal transmission,
an activation and/or a deactivation of the dedicated sidelink positioning resource configuration, and
a time duration of the dedicated sidelink positioning resource configuration being allocated for sidelink positioning reference signal transmission.

20-25. (canceled)

26. A method performed by a location network node, for handling sidelink positioning, wherein the method comprises:
receiving, from a resource allocating node, a dedicated sidelink positioning resource configuration, wherein the dedicated sidelink positioning resource configuration comprises an indication being indicative of a dedicated sidelink positioning resource to be used by a wireless device (WD), during a sidelink positioning procedure, and
sending, to the resource allocating node, a message triggering a sidelink positioning procedure in the dedicated sidelink positioning resource.

27-34. (canceled)
